(19) United States
(12) Patent Application Publication
(10) Pub. No.: US 2013/0117997 A1
(43) Pub. Date: May 16, 2013

(54) System and Method for Installing a Fastener Rod

(71) Applicants: Ryan T. Ehinger, Irving, TX (US); Wayland Hill, Keller, TX (US); Doug Mueller, Coppell, TX (US)

(72) Inventors: Ryan T. Ehinger, Irving, TX (US); Wayland Hill, Keller, TX (US); Doug Mueller, Coppell, TX (US)

(73) Assignee: BELL HELICOPTER TEXTRON INC., Fort Worth, TX (US)

(21) Appl. No.: 13/294,686

(22) Filed: Nov. 11, 2011

(51) Int. Cl. F16B 35/00; B23P 11/00; A47L 13/00

(52) U.S. Cl. 29/525.11; 411/378; 15/104.001

(57) ABSTRACT

A system and method for installing a fastener rod is provided. In one embodiment a fastener rod starter apparatus is provided and may include a first end for engaging a fastener rod, a second end for insertion into an insertion hole, and an elongated body of closed cell foam having sufficiently low density and high compressibility to displace fluid in the insertion hole and be compressed to allow installation of the fastener rod into the insertion hole. A method for installing a fastener rod may include lubricating an insertion hole with a fluid and inserting a starter element into the insertion hole. The starter element may have sufficiently low density and high compressibility to displace the fluid in the insertion hole and be compressed by the fastener rod inserted into the insertion hole.

### BACKGROUND

1. Field of the Invention

This disclosure relates in general to the field of fasteners, and more particularly to a system and method for installing a fastener rod installation.

2. Description of Related Art

Fastener rods, such as dowel pins and threaded studs, can be machined to tight tolerances and are frequently used as fasteners for mechanical components that require such tolerances, such as gear casings, engines, and transmissions in rotorcraft drive systems.

Many close tolerance applications demand an interference fit or transition fit between a fastener rod and a corresponding insertion hole. For metal parts in particular, the friction that holds the parts together is often greatly increased by compression of one part against the other, which relies on the tensile and compressive strengths of the materials the parts are made from.

A liquid primer or oil is often desirable to facilitate a satisfactory fit or reduce corrosion at the interface of the mating components, but the liquid may be highly incompressible and can result in cracked cases due to pressurization or inaccurate install torque when compressed. Systems and methods for remedying this problem can be costly and can result in many scrapped parts.

Thus, the design of a safe, cost-effective system and method for installing fastener rods continues to present significant challenges to engineers and manufacturers.

Although great strides have been made in head coverings, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIGS. 1A-1C are simplified block diagrams of one embodiment of a system and method for installing a fastener rod into an insertion hole according to this specification; and

FIGS. 2A-2C are simplified schematic diagrams that illustrate additional details that may be associated with example embodiments of a rod starter according to this specification.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the novel system are described below. In the interest of clarity, not all features of such embodiments may be described. It should be appreciated that in the development of any such system, numerous implementation-specific decisions can be made to achieve specific goals, such as compliance with system-related and business-related constraints, which will vary from one implementation to another. Moreover, it should be appreciated that such decisions might be complex and time-consuming, but would nevertheless be a routine undertaking for those of ordinary skill in the art having the benefit of this disclosure.

Reference may be made to the spatial relationships between various components and to the spatial orientation of various aspects of components as the system is depicted in the attached drawings. However, as should be recognized by those skilled in the art, the elements, members, components, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the example embodiments described herein may be oriented in any desired direction.

For purposes of illustrating the techniques of a system and method for fastener rod installation with an interference fit in example embodiments, it is important to understand the principles and challenges within a given environment. The following foundational information is offered for purposes of explanation only and, accordingly, should not be construed in any way to limit the broad scope of the system, methods, and potential applications described herein.

The term “fastener” refers generally to a broad class of devices that mechanically join or locate two components together, while the term “fastener rod” refers generally to a subset of solid, cylindrical fasteners. Fastener rods may include threaded rods (e.g., a stud) and unthreaded rods (e.g., a dowel, dowel rod, dowel pin, etc.). Typical drilling and milling operations, as well as manufacturing practices for bolt threads, can introduce mechanical play proportional to the size of the fasteners. However, many types of fastener rods can be machined to tight tolerances, which typically result in significantly less play. Thus, fastener rods can often be used for precise location and mating alignment in machine assembly. In particular, engineers often use dowel holes or stud bosses as reference points to control position variations and to attain repeatable assembly quality. Without such reference points for alignment (e.g., components are mated by bolts only), there can be significant variation, or “play”, in component alignment.

Many engineering applications demand a binding fit between a fastener rod and the components that it joins. For example, an interference fit, also known as a press fit or friction fit, can be achieved by friction after components are mated, rather than by other means of fastening. For metal components in particular, the friction that holds the components together can be greatly increased by compression of one component against the other, which relies on the tensile and compressive strengths and stiffness of the materials the components are made from. A transition fit may also bind two components together, but is not so tight that it prevents disassembly.

A binding fit between a fastener rod and a component can generally be achieved by shaping them so that one or the other (or both) slightly deviate in size from a nominal dimension. For example, an unthreaded rod such as a dowel rod may be machined slightly larger than the nominal dimension for an interference fit. Additionally or alternatively, an insertion hole in a component may be reamed so that it is slightly less than the nominal dimension. If the dowel rod is then pressed into the hole, the dowel rod interferes with the component's occupation of space. The desired result is that they elastically deform slightly, and the interface between them is one of extremely high friction so that even large amounts of torque cannot turn one of them relative to the other. An interference fit may also be used for a threaded rod, such as a stud, with overlapping external and internal threads. For example, an interference fit stud can be used if the stud needs to be restrained in its tapped hole against loosening in service or when a nut is removed.

A primer is often desirable to facilitate an interference fit and/or reduce corrosion in the interface, but the primer may be a highly incompressible fluid and can result in cracked cases or inaccurate install torque when compressed. For example, lubricant in a 5/16″ stud boss can create pressure in excess of 30 ksi after stud installation. Systems and methods for remedying this problem can be costly and can result in many scrapped parts.

For example, a drilled vent hole in a housing can allow fluid (i.e., liquid and/or gas) to escape upon installation, but requires additional machining operations that increases component cost and can result in significant waste. A drilled fastener rod can also allow fluid to escape upon rod installation, but may only be practical for short rods not exposed to the atmosphere where there is a risk of corrosion on the rod interior. Moreover, the cost for such non-standard parts also increases component cost. A keyway or slotted vent may also be cut in the side of a rod, but such a feature can weaken the rod and increase the potential for corrosion. Leaving a sufficient air gap at the bottom of an insertion hole can also reduce pressure, but liquid primer can also build up in the hole if not sufficiently cleaned prior to installation, which can be very susceptible to human error.

In accordance with embodiments disclosed herein, a rod starter insert can substantially reduce or eliminate many of these shortcomings (and others) without modifying parts or significantly increasing cost. In one embodiment, the rod starter insert is a closed-cell foam having a low density and high compressibility, which can be placed in an insertion hole prior to installation of a fastener rod. Thus, the insert can displace fluid (e.g., primer and/or oil) in the hole, but may be significantly compressed during installation such that the fastener rod can be fully installed without over-pressurizing the hole.

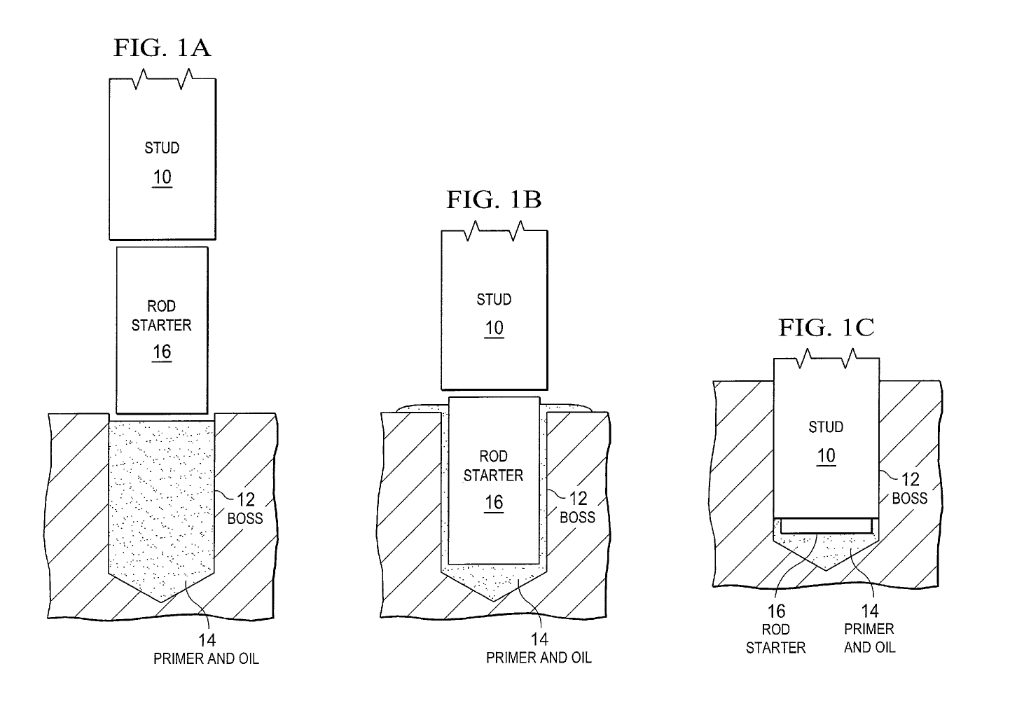

FIG. 1A is a simplified block diagram of one embodiment of a system for installing a fastener rod into an insertion hole. In this particular embodiment, the fastener rod is a stud (i.e., a threaded rod) 10 and the insertion hole is a stud boss 12. Stud 10 and stud boss 12 may be lubricated with a fluid, such as primer and oil 14. A rod starter 16 may be placed over and longitudinally aligned with stud boss 12. FIG. 1B is a simplified block diagram of the system of FIG. 1A in which rod starter 16 is inserted into stud boss 12 to displace primer and oil 14 from stud boss 12. FIG. 1C is a simplified block diagram of the system in FIG. 1A in which stud 10 is installed into stud boss 12. Installation of stud 10 into stud boss 12 compresses rod starter 16. The volume reduction of rod starter 16 may vary considerably based on design requirements, but assuming a 90% reduction in volume, the air pressure in stud boss 12 should only increase by approximately 140 psi. Preferably, stud boss 12 provides sufficient room to accommodate residual fluid, compressed air, and rod starter 16.

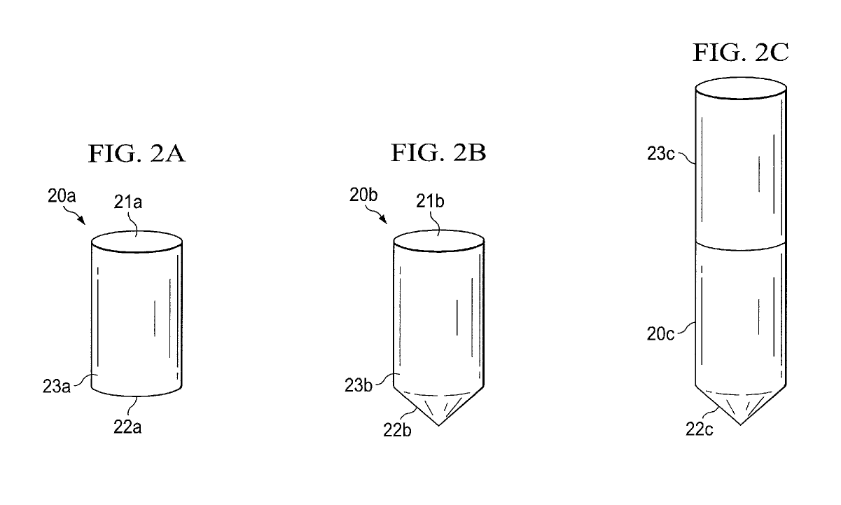

FIGS. 2A-2C are simplified schematic diagrams that illustrate additional details that may be associated with certain example embodiments of a rod starter. In general, a rod starter may be molded, fabricated, or cut to conform to the shape of any insertion hole, but is preferably a cylindrical block element. In FIG. 2A, for example, a rod starter 20a has two opposing ends 21a-22a and an elongated body with a cylindrical wall 23a. Rod starter 20a can be installed in a corresponding insertion hole without regard to orientation of ends 21a-22a. FIG. 2B, however, illustrates a rod starter 20b having a flat end 21b and a distal end 22b adapted to conform to a feature in an insertion hole. For example, distal end 22b may be substantially conical to conform to a drill point in an insertion hole, for example. Thus, rod starter 20b may displace more fluid than rod starter 20a when tapered end 22b is properly oriented and installed in the bottom of a corresponding insertion hole. FIG. 2C illustrates yet another embodiment of a rod starter 20c bonded to a fastener rod 23c. In this particular example, rod starter 20c has a tapered end 22c similar to tapered end 22b, but may alternatively have a flat surface similar to surface 22a. In more particular embodiments, a rod starter may also be sized such that fluid can escape an insertion hole through channels or grooves in the side of the starter rod, or between clearance space between the body of the starter and walls of an insertion hole.

A rod starter element may be constructed from any closed cell foam having sufficiently low density and high compressibility that it can displace fluid in an insertion hole and be compressed to allow full installation of a fastener rod without over-pressurizing the hole. For example, a rod starter element may be constructed from rigid polystyrene foam, including expanded or extruded polystyrene foam (e.g., STYROFOAM).

The system and apparatus described herein provides significant advantages, some of which have already been mentioned. For example, a rod starter as described herein may be a passive device not requiring changes to components or fastener rods. It can be made of highly compressible and rigid closed cell material that can retain its shape to displace fluid yet may be readily compressed during rod installation. Moreover, a rod starter can be sized such that after insertion, fluid in the hole can be compressed to the maximum amount required by a given design with pressurization of the hole well below design limits. A rod starter may be shaped like a cylinder that can be installed in any direction, or like a pointed cylinder that can be installed one way and displace more fluid. A rod starter can also be installed freely prior to rod installation or may be bonded to the rod to further facilitate proper installation.

Certain example embodiments have been shown in the drawings and described above, but variations in these embodiments will be apparent to those skilled in the art. The principles disclosed herein are readily applicable to a variety of industries and mechanical components needing close tolerance fasteners, including rotorcraft drive systems. The preceding description is for illustration purposes only, and the claims below should not be construed as limited to the specific embodiments shown and described.

What is claimed is:

1. A fastener rod starter apparatus, comprising:
a first end for engaging a fastener rod;
a second end for insertion into an insertion hole; and
an elongated body of closed cell foam having sufficiently low density and high compressibility to displace fluid in the insertion hole and be compressed to allow installation of the fastener rod into the insertion hole.

2. The apparatus of claim 1, wherein the elongated body is a substantially cylindrical body.

3. The apparatus of claim 1, wherein the closed cell foam is closed cell polystyrene foam.

4. The apparatus of claim 1, wherein the closed cell foam is closed cell extruded polystyrene foam.

5. The apparatus of claim 1, wherein the second end is adapted to mate with a feature of the insertion hole.

6. The apparatus of claim 1, wherein the second end is conical.

7. The apparatus of claim 1, wherein the fastener rod is bonded to the first end.

8. The apparatus of claim 1, wherein the fastener rod is a threaded fastener rod.

9. The apparatus of claim 1, wherein the fastener rod is a threaded fastener rod bonded to the first end.

10. The apparatus of claim 1, wherein the elongated body comprises channels between the first end and the second end.

11. The apparatus of claim 1, wherein the elongated body is sized to provide a clearance space between the elongated body and the insertion hole.

12. The apparatus of claim 1, wherein:
the elongated body is a substantially cylindrical body;
the closed cell foam is closed cell extruded polystyrene foam;
the fastener rod is bonded to the first end; and
the second end is conical.

13. A fastener rod assembly, comprising:
a fastener rod; and
a closed cell foam starter insert having a first end bonded to the fastener rod.

14. The assembly of claim 13, wherein the starter insert comprises a substantially cylindrical body.

15. The assembly of claim 13, wherein the closed cell foam is closed cell polystyrene foam.

16. The assembly of claim 13, wherein the closed cell foam is closed cell extruded polystyrene foam.

17. The assembly of claim 13, wherein the second end is adapted to mate with a feature of an insertion hole.

18. The assembly of claim 13, wherein the fastener rod is a threaded fastener rod.

19. The assembly of claim 13, wherein the fastener rod is a dowel rod.

20. A method for installing a fastener rod, comprising:
lubricating an insertion hole with a fluid;
inserting a starter element into the insertion hole, wherein the starter element comprises a closed cell foam having sufficiently low density and high compressibility to displace the fluid in the insertion hole and be compressed to allow installation of the fastener rod into the insertion hole; and
inserting the fastener rod into the insertion hole onto the starter element, thereby displacing the fluid in the insertion hole and compressing the starter element.
